(19) United States
(12) Patent Application Publication
(10) Pub. No.: US 2015/0085401 A1
(43) Pub. Date: Mar. 26, 2015

(54) RECORDING MEDIUM HAVING RECORDING ASSIST

(71) Applicant: HGST Netherlands B.V., Amsterdam (NL)

(72) Inventors: Hiroaki Nemoto, Kanagawa (JP); Ichiro Tamai, Kanagawa (JP); Tatsuya Hinoue, Kanagawa (JP); Yuzuru Hosoe, Tokyo (JP)

(73) Assignee: HGST Netherlands B.V., Amsterdam (NL)

(21) Appl. No.: 14/038,492

(22) Filed: Sep. 26, 2013

(51) Int. Cl. G11B 5/82

(52) U.S. Cl. CPC G11B 5/82
USPC 360/135

(57) ABSTRACT

An HDD includes a magnetic head, and a magnetic recording medium. The recording medium includes a recording magnetic layer, and a recording assist magnetic layer, the recording assist magnetic layer generates a high-frequency magnetic field by means of a recording field from the magnetic head, and a recording assist action acts on the recording magnetic layer.

### BACKGROUND

In conventional systems, the areal recording density is increased by improving an existing perpendicular magnetic recording system, such as increasing the magnetic field gradient, reducing the magnetization reversal field distribution of a recording medium, and improving the reproduction output and resolution. However, the areal recording density which can be achieved with these improvements alone is limited.

### BRIEF DESCRIPTION OF THE DRAWINGS

The accompanying drawings, which are incorporated in and form a part of this application, illustrate various embodiments, and together with the description, serve to explain the principles of the various embodiments. Unless noted, the drawings referred to in this description should be understood as not being drawn to scale. It should be noted that a break in a line in the drawings referred to in this description signifies that a line and the perpendicular line(s) crossing it do not connect.

FIG. 1a is a diagram of an example of a hard disk drive.

FIG. 1b is diagram to illustrate the principle of the recording assist effect produced by means of the magnetic recording medium.

FIGS. 2a and 2b depicts an example of the precession of the magnetization in the recording assist magnetic layer.

FIGS. 3a and 3b depicts an example of the precession of the magnetization in the recording assist magnetic layer.

FIGS. 4a and 4b depicts an example of the precession of the magnetization in the recording assist magnetic layer.

FIG. 5 depicts the state of magnetization of the recording magnetic layer and recording assist magnetic layer after recording to the magnetic recording medium.

FIG. 6 depicts the positional relationship of the recording head and magnetic recording medium when the magnetic recording medium is used together with a microwave-assist magnetic recording system.

FIGS. 7a and 7b depicts a layer structure of the magnetic recording film in the magnetic recording medium.

FIG. 8 depicts magnetization curve of the magnetic recording medium.

FIG. 9 depicts a relationship of SNR and thickness tA of the recording assist magnetic layer when recording/reproduction is carried out with a magnetic recording medium in which CoCr alloy is used in the recording assist magnetic layer.

FIG. 10 depicts a relationship of MWW and thickness tA of the recording assist magnetic layer when recording/reproduction is carried out with a magnetic recording medium in which CoCr alloy is used in the recording assist magnetic layer.

FIG. 11 depicts a relationship of SNR and separation layer thickness when recording/reproduction is carried out with a magnetic recording medium in which CoCr alloy is used in the recording assist magnetic layer.

FIG. 12 depicts a relationship of MWW and separation layer thickness when recording/reproduction is carried out with a magnetic recording medium in which CoCr alloy is used in the recording assist magnetic layer.

FIG. 13 depicts the magnetic alloy materials employed in the recording assist magnetic layer and magnetic characteristics of the recording assist magnetic layer.

FIG. 14 depicts a relationship of SNR and thickness tA of the recording assist magnetic layer when recording/reproduction is carried out with a magnetic recording medium in which CoRu alloy and CoCrIr alloy are used in the recording assist magnetic layer.

FIG. 15 depicts a relationship of SNR and thickness to of the recording assist magnetic layer when recording/reproduction is carried out with a magnetic recording medium in which CoCrPt alloy is used in the recording assist magnetic layer.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. Furthermore, in the following description, numerous specific details are set forth in order to provide a thorough understanding of the subject matter. In other instances, conventional methods, procedures, objects, and circuits have not been described in detail as not to unnecessarily obscure aspects of the subject matter.

A magnetic recording medium is used in an information storage device employing a magnetic recording system, for example a hard disk drive (HDD). A magnetic recording medium comprises a magnetic recording film for recording/reproducing/storing recorded information which is indicated by the magnetization direction, and a substrate for supporting said magnetic recording film. Embodiments described herein relates to the layered structure and microstructure of a magnetic recording film which is effective for achieving a high areal recording density using a magnetic recording system.

A hard disk drive (HDD) is an information storage device which is essential for handling large volumes of information in computers and consumer electronics products. In order to achieve high recording capacity while satisfying requirements such as occupying less space and conserving energy it would be desirable to increase the areal recording density.

In conventional systems, the areal recording density has been increased by improving an existing perpendicular magnetic recording system, such as increasing the magnetic field gradient, reducing the magnetization reversal field distribution of a recording medium, and improving the reproduction output and resolution. However, the areal recording density which can be achieved with these improvements alone is estimated to be a maximum of the order of 150 Gbit/cm² (1 Tbit/inch²).

The reason for a limit in the areal recording density is considered to be due to, based in part, on thermal stability of the medium deteriorates if the medium is suitable for increased recording density. A recording magnetic layer which handles the recorded information in a magnetic recording film has a structure in which minute magnetic particles are embedded at high-density, and because the spaces (grain boundaries) between the magnetic particles are filled with a non-magnetic material such as SiO2, exchange interaction which is produced between the magnetic particles is reduced. The characteristic structure of the recording magnetic layer is referred to as a granular structure. In order to perform magnetic recording at a high areal recording density, the magnetic particles are made finer and a recording bit boundary (magnetization transition region) are formed with high precision. However, if the magnetic particles are made finer, the magnetic energy, KuV, which stabilizes the magnetization direction of the magnetic particles is not maintained at a sufficiently high level with respect to the heat energy, kBT, which constitutes disturbance, and therefore a phenomenon occurs whereby the magnetization state recorded is lost after the recording (thermal demagnetization). Here, Ku, V, kB and T indicate the uniaxial magnetic anisotropy energy, the magnetic particle volume, the Boltzmann constant, and the absolute temperature, respectively.

Typically, areal recording density cannot be increased while maintaining thermal stability other than to use a magnetic material having high magnetic anisotropy energy Ku as the material of the magnetic particles. However, magnetic particles having high Ku do not readily undergo magnetic reversal (they have a high magnetic anisotropy field Hk) and as a result it is difficult to perform magnetic recording. This is because the maximum value of the saturation magnetic flux density B of the soft magnetic material used in the recording pole is about 2.5 T, and ultimately there is a limit to the magnitude of the magnetic field which can be generated from the recording pole of a magnetic head which is actually used. In this sense, a main factor in restricting areal recording density is an insufficient recording field.

To overcome the conventional technology, assist magnetic recording has been proposed. In an assist magnetic recording system, assist energy is irradiated onto the recording magnetic layer thereby facilitating magnetization reversal, after which recording bits are formed using the magnetic field generated from the magnetic pole. There are two main assist systems which are proposed: laser heating and microwave excitation; these systems are known, respectively, as thermal-assist magnetic recording (IEEE Trans. Magn., vol. 37, p. 1234 (2001)) and microwave-assist magnetic recording (IEEE Trans. Magn., vol. 44, p. 125 (2008)).

When the abovementioned assist magnetic recording system is implemented, an element for introducing assist energy into a minute region needs to be created inside the magnetic head, and therefore a high level of technical development is required. In the case of the thermal-assist magnetic recording system, an optical waveguide for conducting a beam generated by means of a semiconductor laser up to the recording pole region and a near-field element for narrowing the optical energy therefrom down to a magnitude no greater than several tens of nanometers and irradiating this energy onto a recording medium surface are being developed. In the case of the microwave-assist magnetic recording system, a spin torque oscillator (STO) which can generate a high-frequency magnetic field having a frequency of 10 GHz or more and a maximum field amplitude of 40 kA/m or more in the region of the recording pole is being developed.

However, these technical developments are in themselves of course difficult, and there are problems in terms of cost increases and reductions in yield due to the structure of heads employing this technology and the complexity of the production process.

Embodiments, described herein, overcome the shortcomings, as described above. Various embodiments include a structure which provides a function for assisting magnetic recording inside a magnetic recording medium. Specifically, another magnetic layer having a granular structure is provided in the region on the substrate side of a recording magnetic layer. This newly provided magnetic layer will be referred to below as a recording assist magnetic layer.

The magnetic particles forming this recording assist magnetic layer have a greater degree of soft magnetism than the magnetic particles forming the recording magnetic layer, and they have magnetic characteristics whereby the magnetization direction is changed while closely following the magnetic field from the recording pole. Magnetic characteristics such as these are generally achieved by reducing the magnetic anisotropy field Hk of the magnetic material forming the magnetic particles of the recording assist magnetic layer. In order to achieve this under a realistic recording field from a magnetic head, the absolute value of the magnetic anisotropy field Hk_A of the recording assist magnetic layer is set to 600 kA/m or less, for example. In this instance, the Hk_A of the recording assist magnetic layer is negative (magnetic characteristics having an easy direction of magnetization in a plane perpendicular to a specific axis).

Magnetic materials composed of Co alloys containing elements such as Cr, Ni, Fe, Ru, Ir, Pd, Rh, Pt, have low Hk which is required for soft magnetic characteristics described above, and a crystalline structure similar to that of the CoCrPt alloy-based magnetic materials which have been conventionally used as the material of the recording magnetic layer. It should be noted that in this instance, if an element which can demonstrate strong magnetic anisotropy, such as Pt, is added to the Co alloy, care is taken to keep the composition of the element to a low level so that the magnetic anisotropy field is not excessively large. In addition, a suitable amount of non-magnetic grain-boundary material is added to the recording assist magnetic layer in order to impart a granular structure. The same materials used in the recording magnetic layer may be selected as the non-magnetic grain-boundary materials, and oxides or the like may be used.

The greater the thickness tA and the saturation magnetization Ms_A of the recording assist magnetic layer, the stronger the assist effect demonstrated by the recording assist magnetic layer. In order to produce an assist effect, the product of the thickness and saturation magnetization is increased to a certain extent, for example 0.8 mA (0.08 memu/cm2) or greater. This corresponds to a case in which tA=2 nm and Ms_A=400 kA/M, for example. On the other hand, if Ms_A·tA is excessively large, the reproduction signal quality deteriorates, so Ms_A·tA may be kept to 5 mA (0.5 memu/cm2) or less.

The recording assist magnetic layer is separated from the recording magnetic layer by way of a separation layer, but is provided at a position as close as possible to the recording magnetic layer. That is to say, although magnetic exchange interaction does not take place between these layers, they are arranged in such a way that magnetostatic interaction takes place therebetween. In order to adequately separate exchange interaction between the recording magnetic layer and the recording assist magnetic layer, the thickness of the non-magnetic separation layer inserted between the two magnetic layers should be set at 0.5 nm or more, for example. Furthermore, in order to produce effective magnetostatic interaction between the magnetic particles in the two magnetic layers, the thickness of the separation layer introduced between the two magnetic layers should be as small as possible. For example, this thickness is around half or less of the diameter of the magnetic particles forming the two magnetic layers, and because the typical size of magnetic particles in a recording magnetic layer for a current HDD magnetic recording medium is 10 nm at the most, the thickness of the non-magnetic layer is no greater than 5 nm.

The separation layer may utilize a material that can adequately reduce exchange interaction between the two magnetic layers and can also maintain the crystal orientation of the recording magnetic layer formed thereon. Possible candidates include metallic Ru having an hcp structure, and CoCr, CoRu, CrRu, CoCrRu, and RuTi alloy etc. In addition, a small amount of metal additives may also be mixed therewith, as appropriate, and oxide materials may also be added in order to promote the appearance of a granular structure, as desired.

The positions of the magnetic particles in the recording magnetic layer should correspond one-to-one with the positions of the magnetic particles in the recording assist magnetic layer within a magnetic recording film. That is to say, the granular structure of the recording magnetic layer matches the granular structure of the recording assist magnetic layer. The magnetic recording films are normally formed in succession from a layer on the substrate side, and therefore the recording magnetic layer is formed after the recording assist magnetic layer has been formed, with a very thin non-magnetic layer interposed. It is therefore possible to form a grain boundary from the initial region of the recording magnetic layer by making the granular structure of the recording magnetic layer imitate the granular structure of the recording assist magnetic layer below. As a result, exchange interaction between the magnetic particles in the lower part of the recording magnetic layer can be adequately restricted and the magnetic characteristics of the recording magnetic layer can be properly controlled.

In one embodiment, forming the granular structure of the recording assist magnetic layer involves providing a layer constituting a template for the granular structure below the recording assist magnetic layer. The crystal orientation and granular structure of the recording magnetic layer are controlled by providing a texture control layer comprising Ru or Ru alloy and a seed layer comprising Ni alloy or the like below the recording magnetic layer. The same method may also be used for the recording assist magnetic layer.

Co alloy-based magnetic materials which are employed in conventional magnetic recording films may be used as described above. However, other types of magnetic materials may be used. For example, the medium structure may be realized by using an FePt ordered alloy-based material in order to achieve higher magnetic anisotropy energy (anisotropy field). For example, FePt alloy having an unordered fcc (A1) structure may be provided as the recording assist magnetic layer, and an FePt alloy having an ordered L10 structure may be provided as the recording magnetic layer. FePt alloy is known to become ordered under heating, but the ordering does not readily progress if the ratio of Fe and Pt compositions deviate from unity. The soft magnetic characteristics can therefore be achieved by varying the compositional ratio of FePt alloy from 1-to-1 in the recording assist magnetic layer.

It should be noted that, in conventional magnetic recording films, a magnetic layer having soft magnetic characteristics known as a soft magnetic underlayer (SUL) is generally provided on the substrate side of the recording magnetic layer. If a texture control layer and a seed layer are used as described above, the SUL is placed below these layers. Although the recording assist magnetic layer has soft magnetic characteristics, it differs from a conventional SUL in that it must have a granular structure which essentially matches the recording magnetic layer, is disposed in proximity to the recording magnetic layer, and includes the abovementioned thickness and magnetic characteristics. Furthermore, the recording assist magnetic layer may be used together with an SUL.

In a magnetic recording medium having the abovementioned structure, magnetization reversal of the magnetic particles in the recording magnetic layer is assisted by the recording assist magnetic layer behaving in the following manner during the process of magnetic recording performed by a conventional magnetic head, and the insufficiency of the recording field from the recording pole is compensated. The magnetic recording medium demonstrates better recording/reproduction performance than a conventional medium because of this recording assist effect.

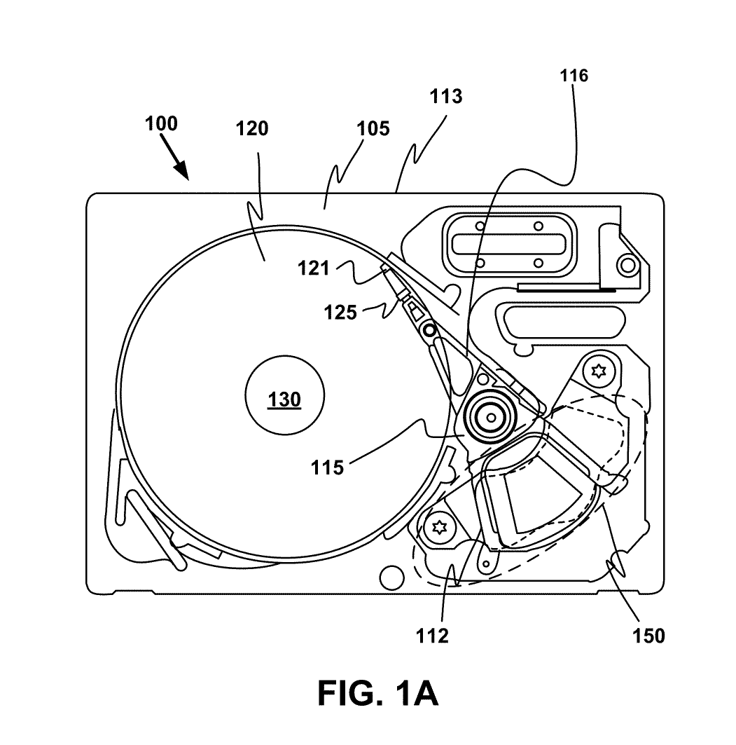

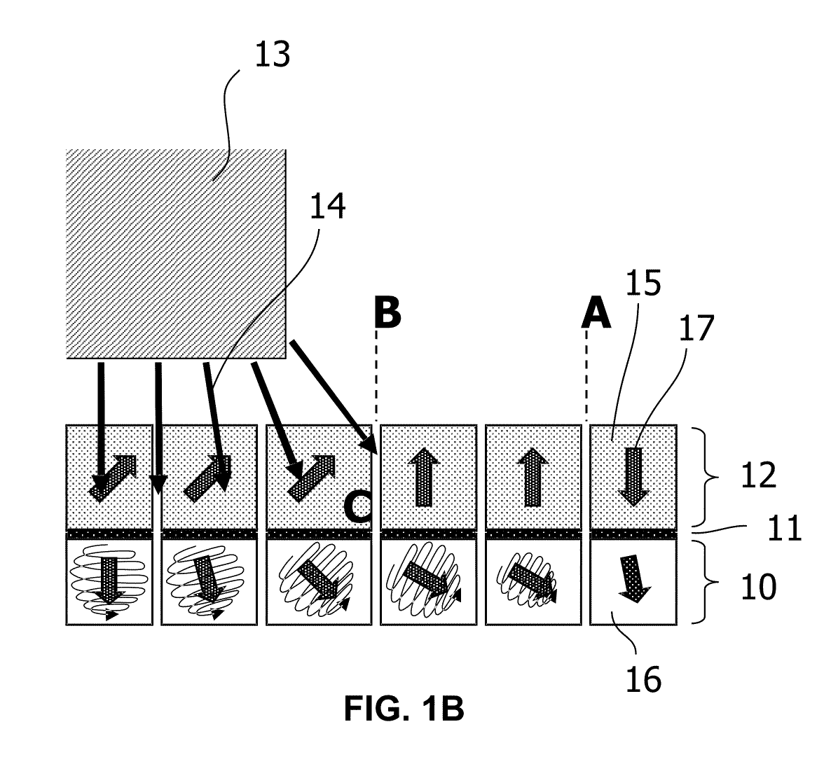

With reference now to FIG. 1A, a schematic drawing of one embodiment of an information storage system including a magnetic hard disk file or HDD 100 for a computer system is shown, although one head and one disk surface combination are shown. What is described herein for one head-disk combination is also applicable to multiple head-disk combinations. In other words, the present technology is independent of the number of head-disk combinations.

In general, HDD 100 has an outer sealed housing including a base portion 105 and a top or cover (not shown). In one embodiment, housing contains a disk pack having at least one media or magnetic disk 120. The disk pack (as represented by disk 120) defines an axis of rotation and a radial direction relative to the axis in which the disk pack is rotatable.

A spindle motor assembly having a central drive hub 130 operates as the axis and rotates the disk 120 or disks of the disk pack in the radial direction relative to housing 113. An actuator assembly 115 includes one or more actuator arms 116. When a number of actuator arms 116 are present, they are usually represented in the form of a comb that is movably or pivotally mounted to base 105. A controller 150 is also mounted to base 105 for selectively moving the actuator arms 116 relative to the disk 120.

In one embodiment, each actuator arm 116 has extending from it at least one cantilevered integrated lead suspension (ILS) 125. The ILS 125 may be any form of lead suspension that can be used in a data access storage device. The level of integration containing the slider 121, ILS 125, and read/write head is called the Head Gimbal Assembly (HGA).

The ILS 125 has a spring-like quality, which biases or presses the air-bearing surface of slider 121 against disk 120 to cause slider 121 to fly at a precise distance from disk 120. ILS 125 has a hinge area that provides for the spring-like quality, and a flexing cable-type interconnect that supports read and write traces and electrical connections through the hinge area. A voice coil (not shown), free to move within a conventional voice coil motor (VCM) 112 is also mounted to actuator arms 116 opposite the head gimbal assemblies. Movement of the actuator assembly 115 by controller 150 causes the head gimbal assembly to move along radial arcs across tracks on the surface of disk 120.

FIG. 1B schematically shows the magnetization behavior of a recording assist magnetic layer 10 and a recording magnetic layer 12 in the recording process of the magnetic recording medium (e.g., magnetic disk). In particular, magnetization vector 17 in magnetic grain. Separation layer 11 is interposed between recording assist magnetic layer 10 and recording magnetic layer 12. In order to orient the magnetization of the recording magnetic layer 12 upward or downward with respect to the medium surface, a recording field 14 with its polarity varying at predetermined timing is applied from a recording pole 13, while the surface of the recording medium is scanned by a magnetic head. In FIG. 1B, magnetization transition (a point where the polarity of the magnetization direction changes) has already been formed at a point A, and magnetization transition at a point B is about to be formed by reversing the magnetization of magnetic particle C. In this process, the recording assist magnetic layer 10 which is located closely below the recording magnetic layer 12 is also affected by the recording field 14. The recording assist magnetic layer 10 has soft magnetic characteristics and therefore it follows the reversal of the recording field 14 and the magnetization of magnetic particles 16 therein are reversed over a wide range in the area around the recording pole.

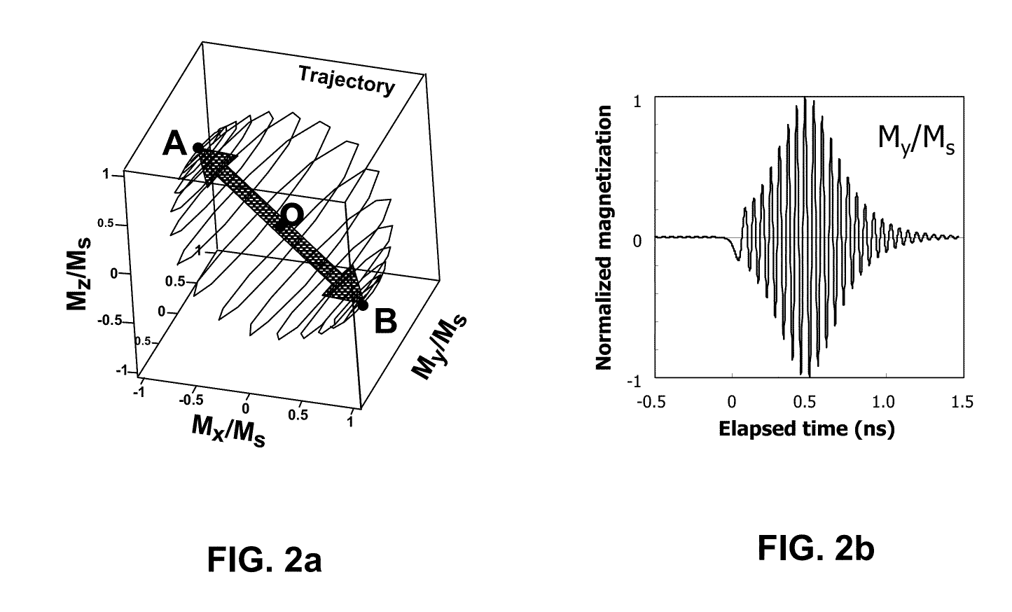

When the magnetization of the recording assist magnetic layer 10 is reversed following the reversal of the recording field, the magnetization does not change direction linearly from the initial angle to the final angle; rather it comes gradually closer to the final angle accompanying precession, with the magnetic field direction as the axis of rotation. This precession is a fundamental property of a magnetic moment and appears universal when magnetic damping is small (for example, when the damping constant α is 0.1 or less). However, precession is hindered when the recording assist magnetic layer 10 has a large amount of magnetic anisotropy. A specific example of this will be described later with reference to FIGS. 2a to 4b.

The frequency of the precession is a high frequency of 10 GHz or more under a typical magnetic field, and a high-frequency magnetic field is generated from the recording assist magnetic layer 10 while the recording assist magnetic layer 10 is undergoing magnetization reversal. This high-frequency magnetic field has similar properties to the high-frequency magnetic field in a microwave-assist magnetic recording system. This means that the high-frequency magnetic field generated by the plurality of magnetic particles 16 within the recording assist magnetic layer assists the magnetization reversal of magnetic particles 15 within the recording magnetic layer in proximity thereto (magnetic particles C in this case). Consequently, recording can be carried out in the magnetic particles 15 having high Hk by using a magnetic head having the same structure as a conventional one, and the areal recording density can be increased while the thermal stability of the recording magnetic layer 12 is maintained. Magnetization reversal of the magnetic particles 16 within the recording assist magnetic layer occurs when the recording field 14 is reversed, so the high-frequency magnetic field is temporarily generated. However, the timing thereof is for assisting recording and the magnetic recording medium such that the magnetic recording medium operates effectively.

FIGS. 2a and 2b show the results of analyzing the state of precession when the magnetic particles within the recording assist magnetic layer undergo magnetic reversal, by means of computer simulation based on the Landau-Lifshitz-Gilbert (LLG) equation which describes the behavior of magnetization. In order to simplify the analysis, an isolated magnetic particle which was a cube having sides of length 8 nm was assumed, and this was divided using a mesh into cubes having sides of length 2 nm. The saturation magnetization Ms_A of the magnetic particles was 500 kA/m, the magnetic anisotropy field Hk was zero, and the damping constant α was 0.05. A magnetic field having an intensity Hext=560 kA/m corresponding to a recording field was initially applied obliquely upward at an angle of 45° and reversed at a predetermined timing. The time taken for reversal of the recording field was 0.2 ns.

FIG. 2a shows the trajectory at the tip end of the magnetization vector during magnetization reversal, and FIG. 2b shows the temporal change in the magnitude of the magnetization component in the Y direction. In the actual recording process, recording is carried out at the rear end of the recording pole, so the recording field is inclined in the direction of advance (the track direction). The −X direction in FIG. 2a can be treated as the direction of advance of the head and the +Z direction can be treated as the direction perpendicular to the medium. In FIG. 2a, there is a large amount of precession from the point A, which is the magnetization direction before the recording field has reversed, to the point B after reversal. FIG. 2b is a diagram in which the temporal change in precession is represented by the magnetization component in the Y direction (the track crosswise direction). The point of origin of the time is the reversal timing of the recording field polarity and the magnetic field changes from −0.1 ns to 0.1 ns. The precession starts immediately after reversal of the recording field and is completed after approximately 1 ns. The frequency of this precession was approximately 19 GHz, from the temporal change in the Y direction component (this essentially matches the frequency f=γHext/2π=21.5 GHz derived from the Kittel formula). The recording assist magnetic layer comprising the abovementioned magnetic particles can therefore generate a high-frequency magnetic field having a frequency of 19 GHz over a period of approximately 1 ns, matching the timing of reversal of the recording field.

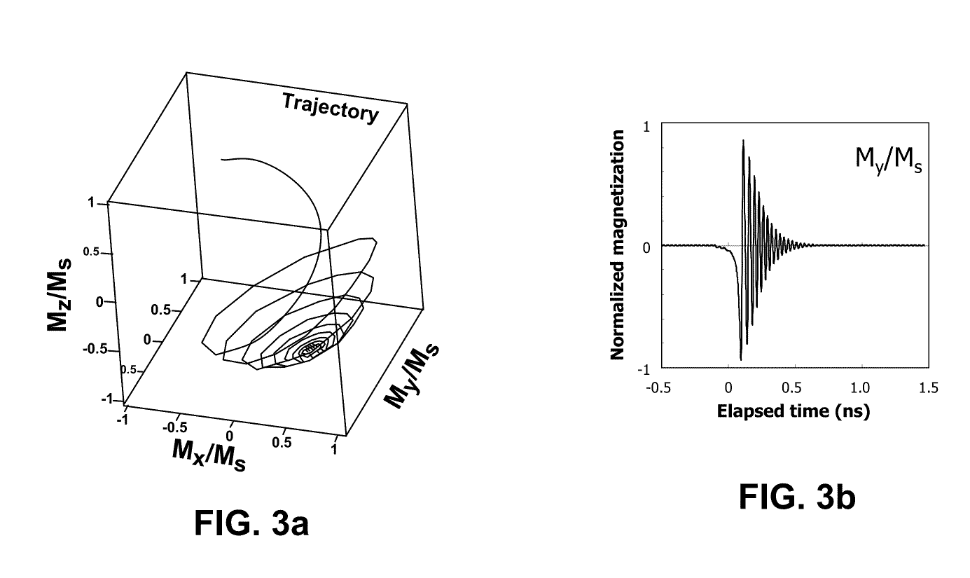

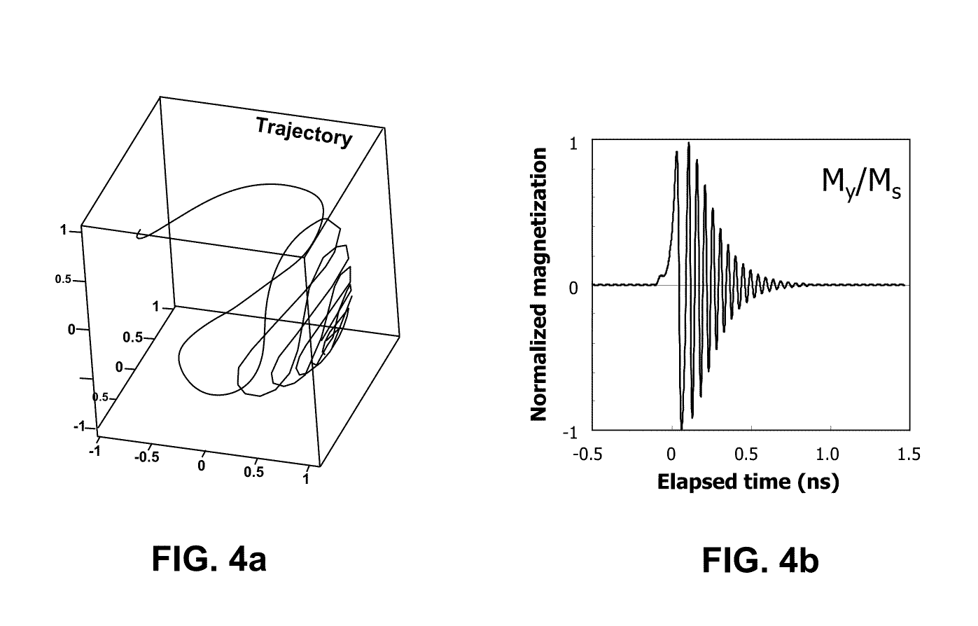

The same calculation as in FIGS. 2a-b was carried out for magnetic particles having uniaxial magnetic anisotropy in the Z-axis direction. FIG. 3a and FIG. 3b shows the calculation results for magnetic particles having positive magnetic anisotropy (magnetization easy axis in a direction perpendicular to the film plane) and a magnetic anisotropy field Hk_A of 636 kA/m. FIGS. 4a-b shows the calculation results for magnetic particles having negative magnetic anisotropy (magnetization easy plane within the film plane) and a magnetic anisotropy field Hk_A of −636 kA/m.

When the particles have strong positive magnetic anisotropy, as in FIGS. 3a-b, magnetization reversal rapidly progresses from an initial stable point at a certain timing, after which the reversal reaches a final stable point while precession takes place at a fairly high frequency. In this case the time over which precession takes place is short and the trajectory of the precession is small, so the high-frequency magnetic field generated is weak. This means that a high recording assist effect cannot be anticipated.

When the particles have strong negative magnetic anisotropy, as in FIGS. 4a-b, the same characteristics as in FIGS. 3a-b are demonstrated and magnetization reversal rapidly progresses from an initial stable point at a certain timing. The direction in which the magnetization is easily oriented is within the X-Y plane so the trajectory of the precession does not form a simple helical shape, and the final stable point is reached in a shorter time while precession takes place at a frequency somewhat higher than in the case of FIGS. 2a-b in which there is no magnetic anisotropy. In this case too, the recording assist effect is believed to be restricted. However, the time over which precession takes place is longer than when there is positive magnetic anisotropy and the trajectory of the precession is also larger. Negative magnetic anisotropy is considered to be a more preferable magnetic characteristic than positive magnetic anisotropy in the recording assist magnetic layer.

It should be appreciated that a high-frequency magnetic field generated from the recording assist magnetic layer acts on the recording magnetic layer. The non-magnetic layer introduced between the two magnetic layers is therefore thinned and the two magnetic layers are allowed to come closer together so that strong magnetostatic interaction is produced between the recording magnetic layer and the recording assist magnetic layer.

On the other hand, exchange interaction between the recording magnetic layer and the recording assist magnetic layer is suppressed sufficiently. For example, the exchange interaction is reduced to a similar level as the magnetostatic interaction or to a lower level. One reason for this is that strong exchange interaction between the two magnetic layers causes a change in the magnetization reversal characteristics which the recording magnetic layer should in itself have, and a sharp magnetization transition is not readily formed in the recording magnetic layer. Another reason is that the capacity of the recording assist magnetic layer to generate a high-frequency magnetic field is reduced by the effect of the recording magnetic layer. That is to say, the two magnetic layers each have different roles: it is important for the recording magnetic layer to provide the role of properly forming recording bits, and for the recording assist magnetic layer to efficiently generate a high-frequency magnetic field.

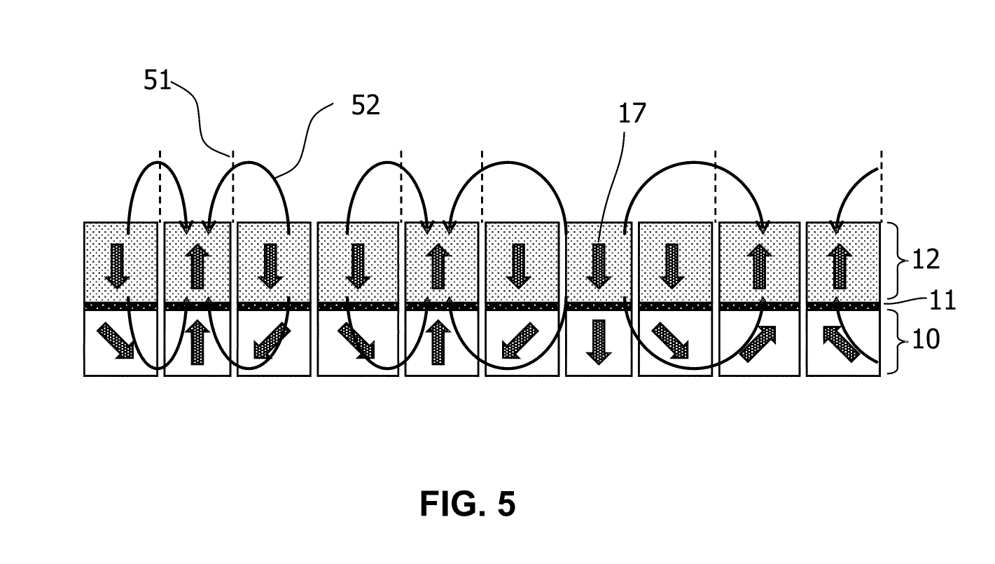

FIG. 5 schematically shows the state of magnetization of the recording magnetic layer and the recording assist magnetic layer after recording has been completed. The recording magnetic layer 12 generates leakage flux 52 in the vertical direction thereof in accordance with the state of recording magnetization thereof. The leakage flux 52 leaving the surface of the medium is used for magnetic reproduction, and in the case of the magnetic recording medium, the leakage flux 52 leaving the substrate side opposite acts on the recording assist magnetic layer 10. If the leakage flux 52 from the recording magnetic layer 12 is strong, the recording assist magnetic layer 10 absorbs the leakage flux thereby forming a closure domain structure, as shown in the example in FIG. 5. When this closure domain structure is formed, the demagnetizing field to the recording magnetic layer 12 is reduced, and therefore it can be anticipated that the stability of the magnetization state in the recording magnetic layer 12 will be enhanced while the signal intensity detected by means of the reproduction head will be increased.

On the other hand, if a closure domain such as that shown in FIG. 5 is not formed because there is weak magnetostatic interaction between the recording magnetic layer 12 and the recording assist magnetic layer 10, the magnetization state of the recording assist magnetic layer 10 is unstable, which causes magnetic noise during magnetic reproduction. For this reason, the magnetostatic interaction acting on the recording magnetic layer 12 and the recording assist magnetic layer 10 is also important and the two magnetic layers should be placed as close as possible together in a range in which there is no exchange interaction.

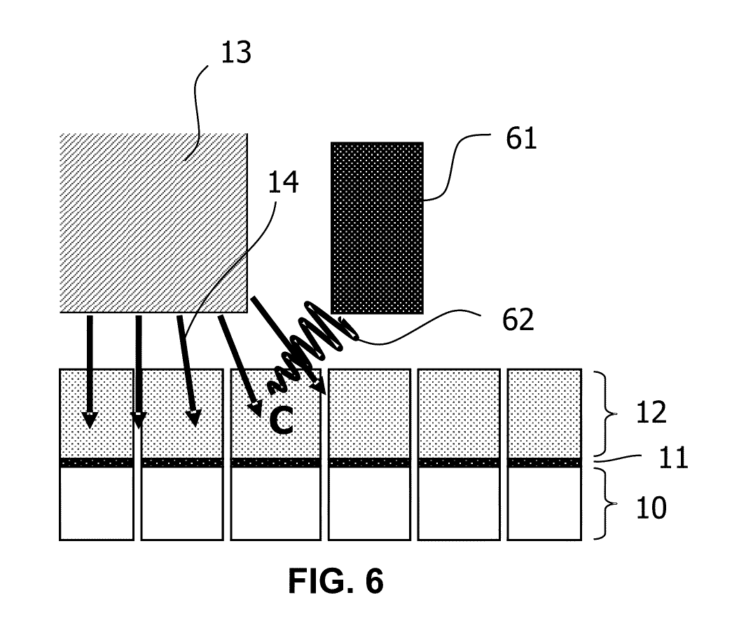

The principle of achieving high recording performance by means of the magnetic recording medium is essentially the same as the principle of a microwave-assist magnetic recording system. FIG. 6 schematically shows the positional relationship of the recording head and the magnetic recording medium in a microwave-assist magnetic recording system. In the microwave-assist magnetic recording system, a high-frequency magnetic field generating element 61 for generating a high-frequency magnetic field 62 is provided close to the recording pole 13, and the magnetization is efficiently reversed by applying the recording field 14 and a high-frequency magnetic field 62 at the same time to the magnetic particles C.

In the magnetic recording medium, the recording assist magnetic layer 10 generates a high-frequency magnetic field and the recording magnetic layer 12 undergoes effective magnetization reversal due to the action of the high-frequency magnetic field. The magnetic recording medium is therefore effective when used in combination with a microwave-assist magnetic recording system. In a microwave-assist magnetic recording system, the high-frequency magnetic field 62 which is generated by the high-frequency magnetic field generating element 61 generally has a different frequency and angle to the high-frequency magnetic field generated by the recording assist magnetic layer 10, but a synergistic assist effect can still be provided for recording to the recording magnetic layer 12 even if the high-frequency magnetic fields differ in this way.

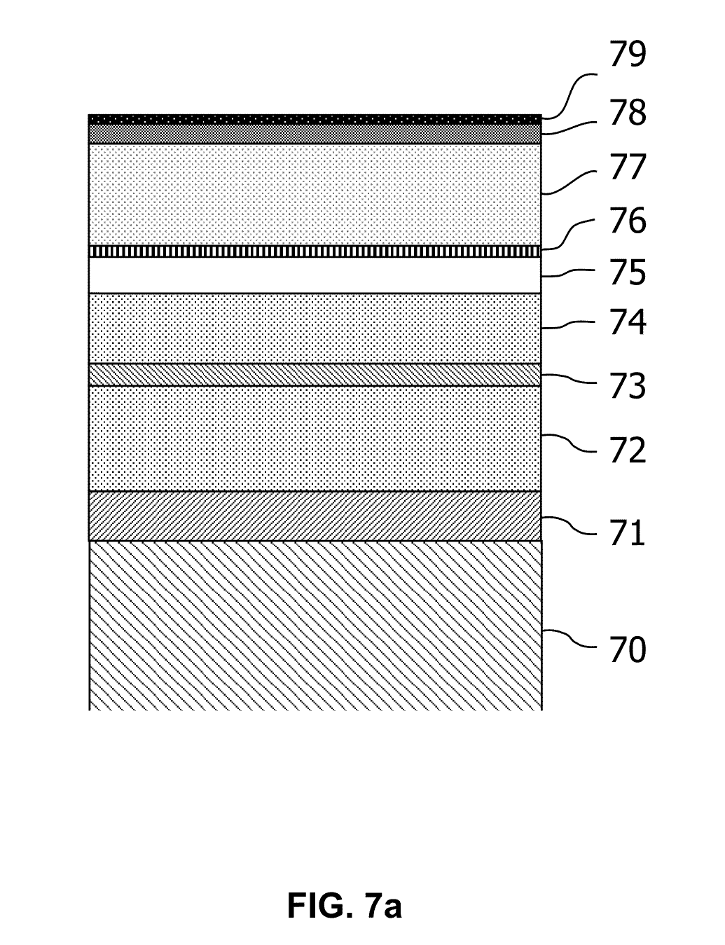

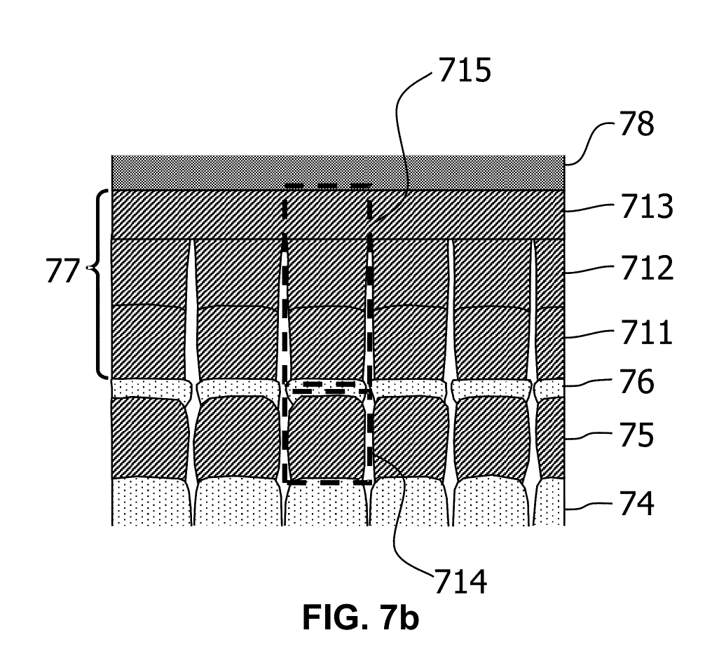

FIG. 7a shows one example of the structure of the magnetic recording film formed on the surface of the magnetic recording medium. FIG. 7a is an overall view thereof. The magnetic recording medium according to this exemplary embodiment comprises a magnetic recording film having a multilayer structure which was formed on a glass substrate 70. An undercoat layer 71 comprising NiTa amorphous alloy was first of all formed to a thickness of 10 nm by means of sputtering, and a soft magnetic underlayer (SUL) 72 was then formed to give a total thickness of 30 nm. The soft magnetic underlayer 72 is generally used in a perpendicular magnetic recording medium and serves to efficiently absorb magnetic flux generated by the recording pole into the magnetic recording film. The soft magnetic underlayer 72 according to this exemplary embodiment had a structure in which two magnetic layers comprising FeCo34Ta10Zr5 alloy (the subscript numerical values express the atomic percentage of the element content in the alloy; the same applies below) having a thickness of 15 nm were placed one over another and an Ru layer having a thickness of 0.5 nm was inserted between these two layers. By adopting this structure, noise produced during magnetic reproduction can be suppressed because the FeCo34Ta10Zr5 alloy magnetic double layer couples antiferromagnetically.

A seed layer 73 comprised NiW8 alloy and the thickness thereof was 5 nm. A texture control layer 74 comprised an Ru alloy layer and the thickness thereof was 15 nm. Providing an Ru layer directly below the recording magnetic layer is a standard technique in perpendicular magnetic recording media. A good granular structure can be formed with the effect of the Ru layer, which causes an hcp(00.1) crystalline orientation of a Co-based magnetic alloy, which is the material of the recording magnetic layer, and forms a polycrystalline structure and surface roughness constituting the growth nucleus of the magnetic alloy particles.

In this embodiment, a recording assist magnetic layer 75 was formed on the texture control layer 74. A material in which a suitable amount of silicon oxide (SiO2) was added to CoCr alloy, CoRu alloy, CoCrPt alloy, or CoCrIr alloy was used as the material of the recording assist magnetic layer 75. These alloys all have an hcp crystalline structure. The thickness of the recording assist magnetic layer 75 was varied between 1 nm and 20 nm. Furthermore, a comparative sample in which the recording assist magnetic layer 75 was not inserted was also prepared.

After the recording assist magnetic layer 75, a separation layer 76 for breaking exchange interaction between the recording assist magnetic layer 75 and the recording magnetic layer 77 was formed. The separation layer 76 was an Ru metal layer and the thickness thereof was varied between 0 nm and 8 nm. The separation layer 76 was also excluded from the comparative sample which did not have the recording assist magnetic layer 75.

A recording magnetic layer 77 comprised three layers having CoCrPt or CoCrPtB alloy as the starting material thereof. In a first granular magnetic layer 711, a suitable amount (approximately 7 mol %) of silicon oxide was added to CoCr10Pt20 alloy for the granular structure, and the thickness thereof was 7 nm. In a second granular magnetic layer 712, approximately 4 mol % of silicon oxide was added to CoCr16Pt14 alloy for the granular structure, and the thickness thereof was 5 nm. A cap magnetic layer 713 comprised CoCr12Pt16B8 alloy and the thickness thereof was 3.5 nm.

As shown in FIG. 7b, by adding oxide and suitably adjusting the film forming conditions, what is known as a granular structure was formed from the texture control layer 74 up to the second granular magnetic layer 712. Here, the crystalline alloy of each layer was epitaxially grown on the layer directly below and the film-forming process conditions were controlled in such a way that the grain boundary positions were the same so that it was possible to maintain a desirable granular structure in all of the layers. The cap magnetic layer 713 did not contain oxide and was a continuous film without a granular structure. This cap magnetic layer 713 is also often used in conventional perpendicular magnetic recording media and is known to have an effect of improving recording performance by optimizing exchange interaction produced between magnetic particles 715 in the recording magnetic layer 77, and improving corrosion resistance by means of surface planarization.

The film-forming process until this point was carried out by means of sputtering. After the recording magnetic layer 77 had been formed, a carbon protective film 78 having a thickness of 3.0 nm was formed by means of plasma CVD which is one type of chemical vapor deposition, and a sample was retrieved from the vacuum process apparatus. In addition, a sample for carrying out recording/reproduction measurements was coated with a PFPE-based liquid lubricant using a dip process. The thickness of the lubricant film 79 formed was approximately 1.0 nm. Before the recording/reproduction characteristics were evaluated, the surface was burnished to remove projections and foreign matter, and it was confirmed in advance that there was no problem in terms of the head flying characteristics using a glide head.

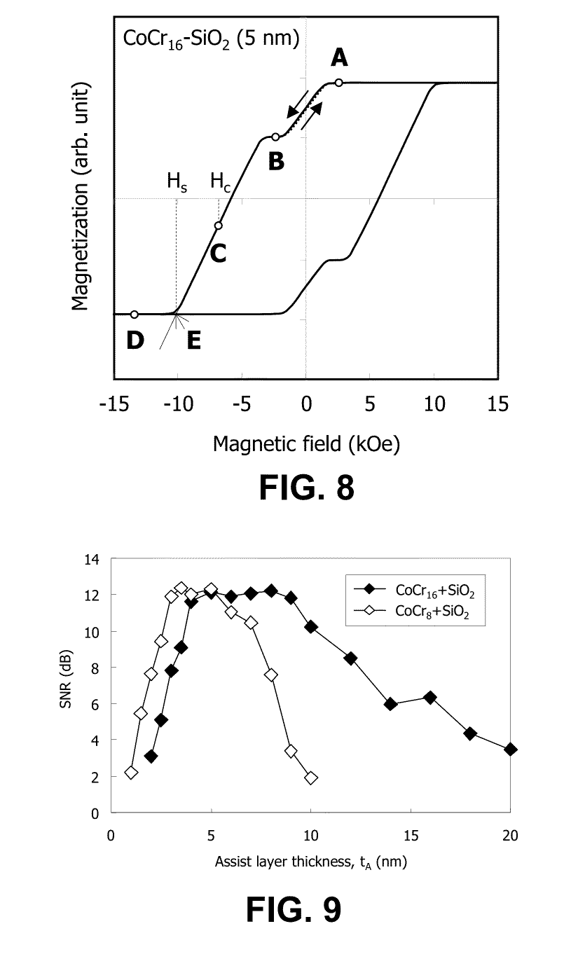

FIG. 8 shows an example in which the magnetization curve of the magnetic recording medium of this exemplary embodiment was measured using the polar Kerr effect. The recording assist magnetic layer 75 of this medium was formed to a thickness of 5 nm by adding approximately 6 mol % of SiO2 to CoCr16 alloy. Furthermore, the thickness of the Ru layer constituting the separation layer 76 was 1.5 nm. The change in the magnetization curve from the point A to the point B corresponds to the magnetization reversal of the recording assist magnetic layer 75. The magnetization curve of the recording assist magnetic layer 75 can be tracked by virtue of the fact that the magnetic field is changed from the point A to the point B, and the magnetic field is then returned from the point B to the point A, but at this point the return to the point B occurs on essentially the same path, as shown by the dotted line in FIG. 8. No exchange interaction is produced between the recording assist magnetic layer 75 and the recording magnetic layer 77 because the magnetization reversal between the points A-B is symmetrical with respect to the origin of the applied magnetic field. The recording assist magnetic layer 75 has soft magnetic characteristics because the coercive force of the magnetization curve between the points A-B is small.

Magnetization reversal of the recording magnetic layer 77 may occur from the point B in FIG. 8 to the point D. Focusing on this section, the coercive force Hc can be read from the magnetic field at the point C which is the position at which magnetization of the recording magnetic layer 77 is reversed by half. Furthermore, the magnetization curve in the magnetization reversal region is extrapolated as a linear approximation, and the magnetic field at the point E which reaches the level of saturation magnetization is read as the saturation magnetic field Hs. Hc of the recording magnetic layer 77 of this medium was 545 kA/m (6850 Oe) and Hs was 805 kA/m (10120 Oe).

A magnetization curve such as this can be measured by a magnetometer employing the polar Kerr effect, and also by a vibrating sample magnetometer (VSM) or the like. If the location where magnetization reversal occurs can be identified from the shape of the magnetization curve as shown in FIG. 8 using a VSM, the product of the saturation magnetization Ms and film thickness t (Ms·t) of the recording assist magnetic layer 75 and recording magnetic layer 77 can be separately determined.

The recording performance was measured by combining a magnetic head produced for use in a perpendicular magnetic recording system with the magnetic recording medium according to this exemplary embodiment. Signals were recorded to and reproduced from a magnetic recording medium produced for testing using the same magnetic head, and the recording performance of the media was compared.

The recording element of the magnetic head employed in the measurements was a shielded head in which a shield was provided on the rear end face and the two side faces of the recording pole, the recording pole width was approximately 50 nm, and the distance between the recording pole and the shield on the rear end face was approximately 30 nm. The reproduction element comprised a tunnel magnetoresistance (TMR) element, the element width was 35 nm, and the shield gap length was approximately 28 nm. The disk rotation speed was set in such a way that the linear velocity of the head with respect to the medium surface was 10 m/s, and the distance from the recording/reproduction element to the medium surface was controlled to approximately 2 nm using a heater built into the magnetic head when the recording/reproduction operations were carried out.

Under the abovementioned conditions, recording was first of all carried out in such a way that the linear density of the magnetization transition (flux change: FC) was 1000 kFCI (1 million per inch), and the signal-to-noise ratio (SNR) was measured by reproducing the signals. The linear density corresponds to the magnetization transition interval (recording domain length) of 25.4 nm. In addition, the reproduction signal intensity was measured while the tracking position of the reproduction element was offset from the center of the recording track, and the recording track width (magnetic write width: MWW) was calculated from the half-width of the profile of the reproduction signal intensity with respect to the tracking position.

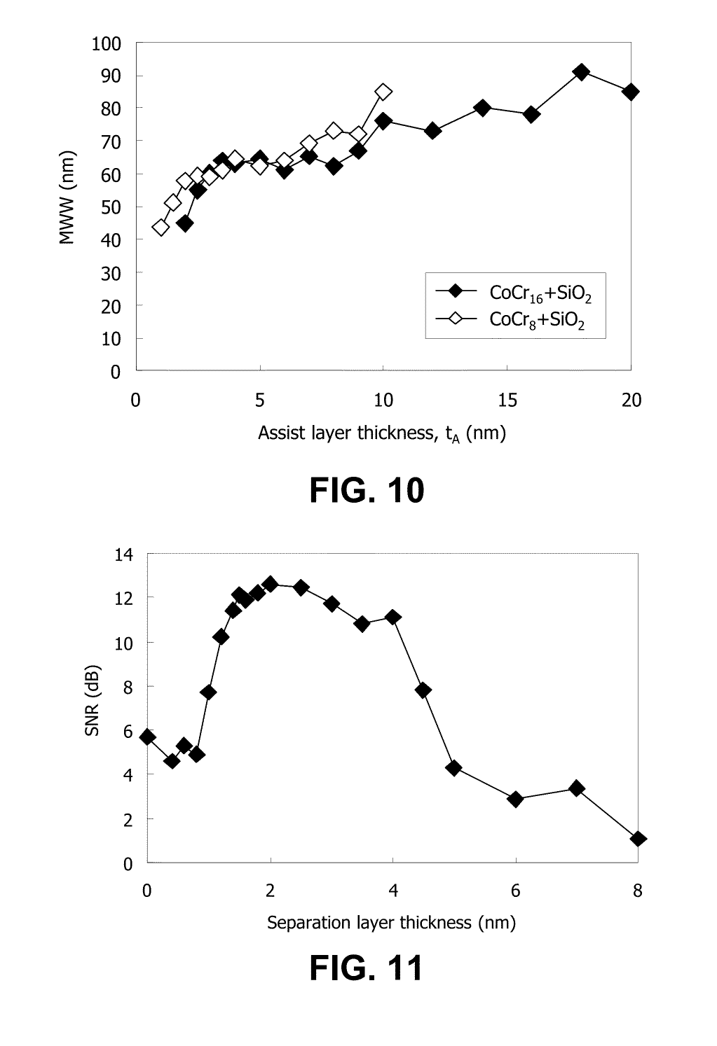

FIG. 9 shows the change in medium SNR when the thickness tA of the recording assist magnetic layer 75 was varied, and FIG. 10 likewise shows the change in MWW. CoCr8 alloy or CoCr16 alloy was used as the material of the recording assist magnetic layer 75 and approximately 6 mol % of SiO2 was added to these magnetic alloys to form a film. The recording assist magnetic layers 75 were granular magnetic layers having soft magnetic characteristics, and the saturation magnetization Ms_A was approximately 850 kA/m for the CoCr8 alloy and 500 kA/m for the CoCr16 alloy. The conditions of the separation layer 76 and recording magnetic layer 77 were generally constant, the thickness of the separation layer 76 was fixed at 1.5 nm, and the coercive force Hc and saturation magnetic field Hs of the recording magnetic layer 77 were essentially constant in the range of 530-550 kA/m (6660-6910 Oe) and 795-825 kA/m (9990-10370 Oe), respectively.

Recording was very difficult with the magnetic head employed for the measurements in the case of the comparative medium which did not have the recording assist magnetic layer 75, and it was not possible to obtain significant SNR and MWW measurement values as shown in FIGS. 9 and 10. The same applied to a region in which the recording assist magnetic layer 75 was very thin. When the recording assist magnetic layer 75 was made thicker, the reproduction signal of the recorded information could be confirmed from the region of tA=1 nm with the CoCr8 alloy and from the region of tA=2 nm with the CoCr16 alloy. This result indicates that a level at which the reproduction signal could be detected was reached with the abovementioned tA, but does not mean that there would be no effect if the recording assist magnetic layer 75 were thinner than this. Rather, this suggests that a recording assist effect is still demonstrated if the recording assist magnetic layer 75 is fairly thin.

The thickness tA at which an effect started to be apparent was smaller in the case of the CoCr8 alloy than in the case of the CoCr16 alloy. This is because the saturation magnetization Ms_A of the CoCr8 alloy is larger. At the thickness tA at which the reproduction signal started to be apparent, the Ms_A·tA value was approximately 1 mA in the case of the CoCr8 alloy and was approximately 0.85 mA in the case of the CoCr16 alloy. The magnitude of the effect of the recording assist magnetic layer 75 can be generally expressed by Ms_A·tA because the two are largely the same.

In FIGS. 9 and 10, SNR and MWW became constant values after increasing to a certain extent as tA increased. In this region, good recording characteristics were realized due to the effect of the recording assist magnetic layer 75. When tA increased further, the SNR in FIG. 9 once again tended to decrease, and MWW in FIG. 10 gradually increased. A number of causes are supposed for the phenomenon in FIG. 9 whereby SNR decreased when tA was excessively great, but one of these causes is believed to be that the noise arising from the recording assist magnetic layer 75 is superimposed on the reproduction signal when the recording assist magnetic layer 75 is excessively thick. On the other hand, the recording assist effect is so enhanced that MWW gradually increases, as shown in FIG. 10. At the tA at which SNR deterioration started in FIG. 9, the Ms_A·tA value was approximately 5.1 mA in the case of the CoCr8 alloy and approximately 5 mA in the case of the CoCr16 alloy. In order to avoid SNR deterioration, the saturation magnetization and thickness of the recording assist magnetic layer 75 should therefore be set under a condition such that Ms_A·tA is no greater than 5 mA.

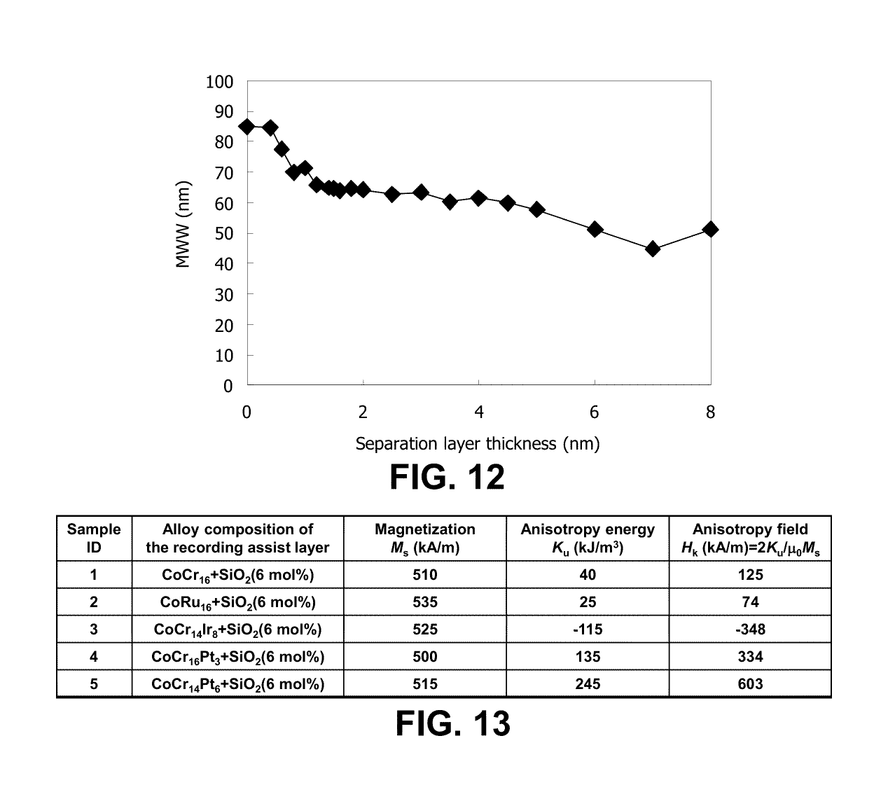

FIG. 11 shows the change in medium SNR when the thickness of the separation layer 76 was varied, and FIG. 12 likewise shows the change in MWW. The thickness of the recording assist magnetic layer 75 was set at 5 nm, and approximately 6 mol % of SiO2 was added to CoCr8 magnetic alloy in order to form a film. The magnetic characteristics of the recording magnetic layer 77 were largely the same as before.

When the thickness of the separation layer 76 was less than 1 nm, SNR had a low value at around 5 dB, as shown in FIG. 11, while a recording track having a relatively large width was formed, as shown in FIG. 12. Exchange interaction was produced between the recording assist magnetic layer 75 and the recording magnetic layer 77 when the separation layer 76 was excessively thin, so the recording magnetic layer 77 readily underwent magnetic reversal and the actual recording was facilitated. However, the magnetization reversal characteristics of the recording magnetic layer 77 considerably deteriorated, so it was difficult to achieve a high SNR.

Exchange interaction between the two magnetic layers decreased and only magnetostatic interaction acted when the thickness of the separation layer 76 was 1 nm or more, and therefore magnetization reversal of the recording magnetic layer 77 was promoted due to the high-frequency magnetic field generated by the recording assist magnetic layer 75. In this case, the inherent recording performance of the recording magnetic layer 77 was fully utilized and SNR in FIG. 11 increased up to approximately 12 dB. However, the intensity of the high-frequency magnetic field acting on the recording magnetic layer 77 decreased when the separation layer 76 was even thicker, and therefore the magnetic assist effect was reduced and SNR in FIG. 11 and MWW in FIG. 12 decreased.

Furthermore, when the separation layer 76 was in the region of 4-5 nm, SNR sharply decreased as shown in FIG. 11. This is believed to be because magnetostatic interaction between the two magnetic layers is weakened, and therefore the action of the recording magnetic layer 77 in stabilizing the magnetization state of the recording assist magnetic layer 75 is lost, and noise arising in the recording assist magnetic layer 75 affects the reproduction signal. When the granular structure of the magnetic recording medium according to this exemplary embodiment was observed by transmission electron microscopy, the average diameter of the magnetic particles was 8.5 nm. As a reference, it is believed that when the thickness of the separation layer 76 exceeds the average radius of the magnetic particles, the stabilizing action of the recording assist magnetic layer 75 is weakened and noise during reproduction reaches a considerable level.

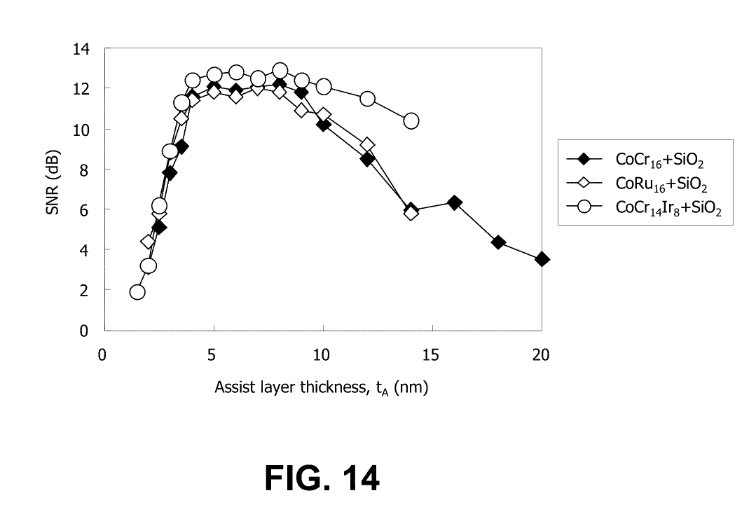

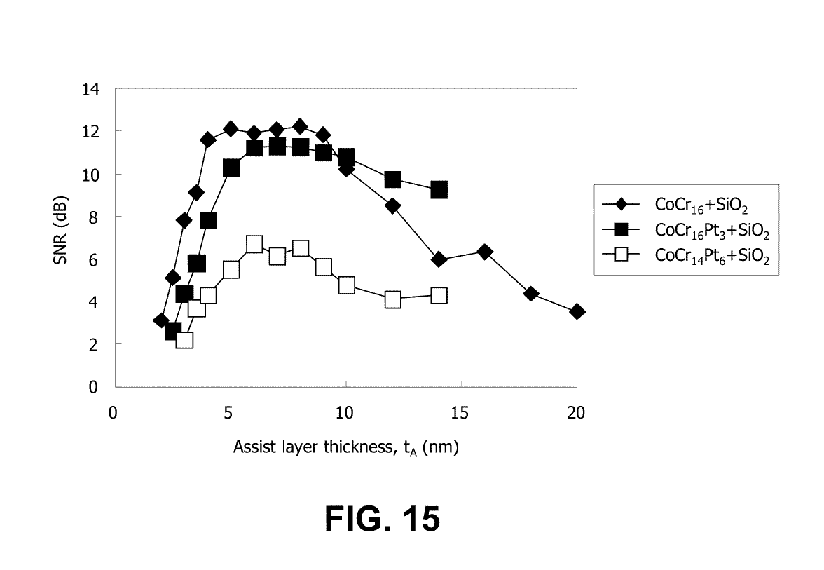

A comparison was made next of the recording assist effect when the magnetic materials used in the recording assist magnetic layer 75 were varied. The types of magnetic materials compared and the magnetic characteristics thereof are shown in FIG. 13. The saturation magnetization of the recording assist magnetic layers 75 was of the order of 500 kA/m in all cases, but the magnetic anisotropy field was varied in the region from −348 kA/m to 603 kA/m. The thickness of the separation layer 76 combined with these recording assist magnetic layers 75 was fixed at 1.5 nm. The magnetic characteristics of the recording magnetic layer 77 were controlled to largely the same level as before. FIGS. 14 and 15 shows the change in medium SNR when the thickness to of recording assist magnetic layers 75 comprising the materials shown in FIG. 13 was varied. For the purposes of comparison, FIGS. 14 and 15 also show data for CoCr16+SiO2 (6 mol %) which is the same as shown in FIG. 9.

FIG. 14 shows a comparison of the results when CoRu16 alloy and CoCr14Ir8 alloy were used and the results for CoCr16 alloy. CoRu16 alloy demonstrates characteristics which are largely comparable with those of CoCr16 alloy. The magnetic anisotropy field is small for both CoRu16 alloy and CoCr16 alloy. It is clear that the recording assist effect is achieved if a certain degree of soft magnetic characteristics is maintained, regardless of the alloy material used. CoCr14Ir8 alloy has a negative value for the magnetic anisotropy field, in other words it has a magnetization easy plane within the film plane. This is the effect of the additional Ir element, and the higher the Ir compositional ratio, the greater the negative magnetic anisotropy demonstrated. In this case also, the recording assist effect achieved was comparable with that of CoCr16 alloy and CoRu16 alloy, and a relatively high SNR could be achieved. One reason for achieving a high SNR is believed to be that a negative magnetic anisotropy field acts to reduce the effect of magnetic noise generated from the recording assist magnetic layer 75 during reproduction. A recording assist magnetic layer 75 having a negative magnetic anisotropy field is thus desirable. However, computer simulations showed that when the negative magnetic anisotropy field is smaller than −600 kA/m, there is a considerable disturbance in the trajectory of the magnetization precession of the recording assist magnetic layer 75, and therefore the alloy composition is adjusted in such a way that the magnetic anisotropy field is no less than −600 kA/m.

FIG. 15 is a comparison of the results when CoCr16Pt3 alloy and CoCr14Pt6 alloy are used and the results for CoCr16 alloy. In the case of CoCr16Pt3 alloy, although the film thickness to at which SNR rises is greater than with CoCr16 alloy and there is something of a risk of a reduction in the recording assist effect, a fairly high value was achieved for the maximum SNR. However, in the case of CoCr14Pt6 alloy, the maximum SNR decreased by 5 dB or more compared with CoCr16 alloy, and the function in terms of the recording assist magnetic layer 75 was considerably reduced. When the Pt element was added to the recording assist magnetic layer 75, a positive anisotropic magnetic anisotropy field was generated and the magnetic anisotropy field was generally greater the higher the Pt compositional ratio. It is believed that the assist effect in magnetization reversal of the recording magnetic layer 77 is reduced when the positive magnetic anisotropy field is excessively large because precession of the magnetization during magnetization reversal of the recording assist magnetic layer 75 is no longer smooth. Furthermore, it is also believed that when there is an intense positive magnetic anisotropy field, the magnetization of the recording assist magnetic layer 75 after recording is fixed upward or downward in the direction perpendicular to the film plane, and noise is likely to be produced during reproduction. According to the results of this exemplary embodiment, it is clear that the alloy composition should be selected in such a way that the magnetic anisotropy field is no greater than 600 kA/m.

When the material of the recording assist magnetic layer 75 is selected in the manner described above, the absolute value of the magnetic anisotropy field thereof may be small, and may be no greater than 600 kA/m, to give a specific value. Furthermore, it is very likely that higher recording/reproduction performance will be achieved with a material having a negative magnetic anisotropy field than with a material having a positive magnetic anisotropy field.

Example embodiments of the subject matter are thus described. Although various embodiments have been described in a language specific to structural features and/or methodological acts, it is to be understood that the appended claims are not necessarily limited to the specific features or acts described above. Rather, the specific features and acts described above are disclosed as example forms of implementing the claims and their equivalents. Moreover, examples and embodiments described herein may be implemented alone or in various combinations with one another.

1. An HDD comprising:
a magnetic head; and
a magnetic recording medium, wherein the magnetic recording medium comprises:
a recording magnetic layer;
a non-magnetic layer disposed adjacent said recording magnetic layer; and
a recording assist magnetic layer disposed adjacent said non-magnetic layer, the recording assist magnetic layer generates a magnetic field by means of a recording field from the magnetic head, and a recording assist action acts on the recording magnetic layer.

2. The HDD of claim 1, wherein the recording assist magnetic layer is a soft magnetic layer.

3. The HDD of claim 1, wherein the recording assist magnetic layer is formed on a texture control layer.

4. (canceled)

5. The HDD of claim 1,
wherein said non-magnetic layer is for breaking exchange interaction between the recording magnetic layer and the recording assist magnetic layer.

6. The HDD of claim 1, wherein said recording magnetic layer comprises:
a first granular magnetic layer;
a second granular magnetic layer; and
cap magnetic layer.

7. The HDD of claim 1, wherein the recording assist magnetic layer has a negative magnetic anisotropy field.

8. The HDD of claim 1, wherein the recording assist magnetic layer comprises a cobalt (Co) alloy comprising iridium (Ir).

9. The HDD of claim 1, wherein said recording assist magnetic layer below the recording magnetic layer.

10. A magnetic recording medium comprising:
a recording magnetic layer;
a non-magnetic layer disposed adjacent said recording magnetic layer; and
a recording assist magnetic layer disposed adjacent said non-magnetic layer.

11. The magnetic recording medium of claim 10, wherein the recording assist magnetic layer is a soft magnetic layer.

12. (canceled)

13. The magnetic recording medium of claim 10,
wherein the non-magnetic layer is for breaking exchange interaction between the recording magnetic layer and the recording assist magnetic layer.

14. The magnetic recording medium of claim 10, wherein the recording assist magnetic layer has a granular structure.

15. The magnetic recording medium of claim 10, wherein the recording assist magnetic layer has a negative magnetic anisotropy field.

16. The magnetic recording medium of claim 10, wherein the recording assist magnetic layer comprises a cobalt (Co) alloy comprising iridium (Ir).

17. The magnetic recording medium of claim 10, wherein said recording magnetic layer comprises:
a first granular magnetic layer;
a second granular magnetic layer; and
cap magnetic layer.

18. The magnetic recording medium of claim 10, wherein the recording assist magnetic layer is formed on a texture control layer.

19. The magnetic recording medium of claim 10, the recording assist magnetic layer is configured to generate a high-frequency magnetic field by means of a recording field from a magnetic head.

20. The magnetic recording medium of claim 10, further comprising:
a seed layer disposed below a texture control layer.
